(19) United States
(12) Patent Application Publication
(10) Pub. No.: US 2018/0009343 A1
(43) Pub. Date: Jan. 11, 2018

(54) MASSAGE CELL ARRANGEMENT AND MASSAGE CELL SYSTEM

(71) Applicant: Kongsberg Automotive AB, Mullsjo (SE)

(72) Inventors: Jari Saren, Norrahammar (SE); Ronny Norman, Habo (SE)

(21) Appl. No.: 15/643,726

(22) Filed: Jul. 7, 2017

(30) Foreign Application Priority Data
Jul. 7, 2016 (SE) 1651006-7

(51) Int. Cl. B60N 2/44; A61H 9/00

(52) U.S. Cl. CPC B60N 2/448; A61H 9/0078; A61H 2203/0431

(57) ABSTRACT

A massage cell arrangement for a vehicle seat comprising a plurality of inflatable/deflatable fluid cells arranged in a series of successive fluid cells. The fluid cells are arranged to overlap with one another such that in each pair of successive cells a first cell and a second cell are partially covering each other. A portion of the fluid cells are multi-cells comprising at least two connected fluid cells comprising at least a base fluid cell and a top fluid cell, wherein internal spaces of the fluid cells of the multi-cell are in fluid communication with each other and the top fluid cell and the base fluid cell are arranged in such that the top fluid cell partially covers a major surface of the base fluid cell.

### CROSS REFERENCE TO RELATED APPLICATIONS

This patent application claims priority under 35 U.S.C. §119 to Swedish Patent Application No. 1651006-7, filed Jul. 7, 2016, which is incorporated herein by reference in its entirety.

### TECHNICAL HELD

The present disclosure relates to a massage cell arrangement and to a massage cell system comprising such massage cell arrangement.

### BACKGROUND

Massage systems for vehicle seats may comprise a linear sequence of successive inflatable massage cells which are arranged along the seat underneath the inner surface of the cover of the seat wherein the cells are sequentially inflated/deflated for carrying out a massage function. U.S. Pat. No. 5,135,282 A shows such a massage cells system. By means of a number of controllable valves a propagating sequential inflation along a series of spaced apart air cells starting from the first cell at the lower end of the seat back and continuing cell by cell to the last cell at the upper end of the seat is performed. After all air cells have been inflated a venting line with controllable valves in a corresponding manner sequentially deflates the air cells in the series of air cells starting with the first air cell and then continuously cell by cell until all cells are deflated. The inflation/deflation of the air cells causes a deformation in the backrest which propagates in a wave-like manner.

US 2014/0207333 A1 discloses a massage device which in the lumbar region has three partially overlapping massage cells located underneath the seat cover padding. The massage effect achieved is, however, limited due to the position underneath the seat cover padding.

There is a demand for improved seat massage systems which provides a person seated in the seat with a more continuous and intensified massage experience.

### SUMMARY

It is an object of the present disclosure to provide an improved or at least an alternative massage cell arrangement tier a vehicle seat and a massage system comprising such massage cell arrangement.

The present disclosure is defined by the appended independent claims with embodiments being set forth in the appended dependent claims, in the following description and in the drawings.

According to a first aspect, there is provided a massage cell arrangement for a vehicle seat comprising a plurality of inflatable/deflatable fluid cells arranged in a series of successive fluid cells, each fluid cell having a first and second major surface arranged on substantially opposite sides of the cell, the cell being configured for fluid connection with a fluid system for inflation/deflation of the fluid cell. The cells of a series of successive cells being substantially aligned along the main direction of extension of the series of successive cells, a surface normal of a major surface of a deflated cell being substantially orthogonal to the main direction of extension of the series of successive cells, the fluid cells being arranged to overlap with one another such that in each pair of successive cells a first cell and a second cell are partially covering each other. A portion of the fluid cells in the series of overlapping successive fluid cells are multi-cells comprising at least two connected fluid cells, each multi-cell comprising at least a base fluid cell and a top fluid cell, wherein internal spaces of the fluid cells of the multi-cell are in fluid communication with each other, and wherein the top fluid cell and the base fluid cell are arranged in such a way that the top fluid cell partially covers a major surface of the base fluid cell.

The massage cell arrangement may be arranged directly underneath the seat cover of a seat. It could e.g. be arranged in the back of the seat or in the seat cushion. The seat could be the seat of a vehicle or a seat not arranged in a vehicle, such as e.g. a rest chair.

The fluid used for inflation of the fluid cells is typically a gas, such as ambient air or any other suitable fluid.

All fluid cells in the series of successive fluid cells may be oriented in the same direction.

The first and second major surface of a fluid cell are connected along the periphery to form an inflatable/deflatable cell. The cell may be provided with an opening for connection with the fluid system.

A base and top fluid cell of a multi-cell (and any intermediate fluid cell) may be substantially equal to a single fluid cell used in the series of successive fluid cells. Alternatively, the base and top fluid cells may differ in shape/size from each other and/or from a single fluid cell. In one embodiment all fluid cells, i.e. top fluid cell, base fluid cell and any intermediate fluid cell, of a multi-cell are essentially the same.

That a surface normal to a major surface of a deflated cell is substantially orthogonal to the main direction of extension of the series of successive cells is here meant that the surface normal deviates from the main direction of extension with 90±30°.

That the cells of a series of successive cells are substantially aligned along the main direction of extension of the series of successive cells is here meant that a center point of a cell may deviate from the main direction of extension with 0-50%, preferably less than 20%, of a smallest length of a major surface of the massage cell in a direction orthogonal to the main direction of extension.

Overlap of two adjacent multi-cells in the series of successive fluid cells is such that the base fluid cell of a second multi-cell covers a portion of a major surface area of a top fluid cell of a first multi-cell.

That the top fluid cell and the base fluid cell in a multi-cell are arranged in such a way that the top fluid cell partially covers a major surface of the base fluid cell is here meant that the coverage of a base fluid cell by a top fluid cell is in the main direction of extension of the series of successive fluid cells.

The top fluid cell and the base fluid cell in the multi-cell are, hence, arranged offset in relation to each other such that center points of overlapping major surfaces of the top fluid cell and the base fluid cell do not coincide. The center points are offset in relation to each other in the main direction of extension of the series of successive fluid cells.

That the top fluid cell is arranged to cover the base fluid cell could here mean that they are in direct contact with each other at least at the area of coverage. Alternatively, e.g. one or more intermediate fluid cells may be arranged between the top fluid cell and the base fluid cell such that the top and base fluid cells are not in direct contact with each other at the area of coverage, or at least not along the whole area of coverage.

The base fluid cell in a multi-cell may be arranged to be in fluid connection with a fluid system and may be provided with an opening for connection with the fluid system. An opening for fluid communication between adjacent fluid cells in a multi-cell may be provided in an area of connection between two adjacent fluid cells. Fluid cells may for example be connected at a hinge region. Fluid cells may be connected at an area of overlap of the major surfaces of the fluid cells.

Inflation of the massage cells takes place along the series of fluid cells in a wave-like manner and results in a movement along the extension of the series of fluid cells. The base fluid cell of a multi-cell is fully inflated slightly before the top fluid cell and any intermediate fluid cell of a multi-cell, as fluid from the fluid system first enters the base fluid cell and thereafter flows to any intermediate fluid cell and to the top fluid cell.

The use of multi-cells in the series of fluid cells as compared to the use of single fluid cells in the series of fluid cells results in an even and smoother inflation/deflation of the sequence of overlapping fluid cells and increases the wave-like massage feeling. Further, the stroke during inflation of a multi-cell is larger than the stroke of a single cell and, hence, the pressure by each multi-cell against e.g. the back of someone seated in the seat in which the massage cell arrangement is installed is greater than when single cells are used. Further, the use of multi-cells in which a top cell partially covers a base cell instead of using multi-cells in which the sub-cells are aligned increases the wave-like massage feeling.

For the multi-cells, any intermediate fluid cell may be offset in relation to the top fluid cell and/or the base fluid cell in the main direction of extension of the series of successive fluid cells.

The number of fluid cells in the series of successive fluid cells may be 2-50, 2-40, 2-30, 2-20, 2-10, 5-50, 5-40, 5-30, 5-20, 5-10, 10-50, 10-40, 10-30, 10-20, 20-50, 20-40, 20-30, 30-50 or 30-40.

The number of fluid cells in a multi-cell may be 2 to 5, 2 to 4 or 2 to 3.

A multi-cell comprising five fluid cells, hence, comprises a base fluid cell and a top fluid cell and three intermediate fluid cells. In one embodiment, all multi-cells in the series of fluid cells comprise the same number of fluid cells.

The top fluid cell may cover 10-99% of a major surface of the base fluid cell in multi-cell.

The top fluid cell may cover 10-90%, 10-80%, 10-70%, 10-60%, 10-50%, 10-40%, 10-30%, 10-20%, 20-99%, 20-90%, 20-80%, 20-70%, 20-60%, 20-50%, 20-40%, 20-30%, 30-99%, 30-90%, 30-80%, 30-70%, 30-60%, 30-50%, 30-40%, 40-99%, 40-90%, 40-80%, 40-70%, 40-60%, 40-50%, 50-99%, 50-90%, 50-80%, 50-70%, 50-60%, 60-99% 60-90%, 60-80%, 60-70%, 70-99%, 70-90%, 70-80%, 80-99% or 80-90% of a major surface of the base fluid cell.

The number of multi-cells in relation to the total number of fluid cells in the series of successive fluid cells may be at least 30%, at least 35%, at least 40%, at least 50%, at least 55%, at least 60%, at least 65%, at least 70%, at least 75%, at least 80%, at least 85%, at least 90%, at least 95% or 100%.

The overlap of adjacent massage cells may be such that a first fluid cell covers 10-99% of a major surface of the second fluid cell.

The first fluid cell may cover 10-90%, 10-80%, 10-70%, 10-60%, 10-50%, 10-40%, 10-30%, 10-20%, 20-99%, 20-90%, 20-80%, 20-70%, 20-60%, 20-50%, 20-40%, 20-30%, 30-99%, 30-90%, 30-80%, 30-70%, 30-60%, 30-50%, 30-40%, 40-99%, 40-90%, 40-80%, 40-70%, 40-60%, 40-50%, 50-99%, 50-90%, 50-80%, 50-70%, 50-60%, 60-99%, 60-90%, 60-80%, 60-70%, 70-99%, 70-90%, 70-80%, 80-99% or 80-90% of the major surface of the second fluid cell.

Fluid cells may substantially be made of plastics.

The plastic material may be a plastic film, foil or sheet. The plastic material could e.g. be polyethylene, polypropylene, polyester, polyvinyl chloride or polyurethane. In one example the plastic material is thermoplastic polyurethane (TPU) foil. The material should be sealable to form the cell and facilitate the increase in volume of the cell as the cell is filled with fluid.

The major surfaces of a fluid cell in deflated condition may be substantially polygonal, semi-polygonal, round or oval.

Examples of such polygonal or semi-polygonal surfaces comprise triangular, rectangular, square, diamond-like, pentagonal, hexagonal, heptagonal, octagonal configuration, nonagonal, decagonal surfaces etc.

Corners may be round or sharp.

All fluid cells in a series of successive fluid cells may have the same shape. Alternatively, at least some of the fluid cells may have different shapes. Preferable at least the fluid cells of a multi-cell have the same shape.

The fluid cells in deflated condition may be substantially planar.

Alternatively, the fluid cells in deflated condition may be curved such that the cell exhibits a generally convex first major surface.

Preferably, the fluid cell also exhibits a generally concave second major surface. The convex first major surface and the concave second major surfaces may be complementary surfaces and arranged on substantially opposite sides of the fluid cell.

That the fluid cell is curved in the deflated condition means that even after a plurality of inflations/deflations the cell may remain curved in its deflated condition.

Depending on the degree of inflation, the fluid cell may or may not exhibit any curvature in the inflated condition.

At least some of the fluid cells in the series of fluid cells may be curved. In a multi-cell, preferably all cells are curved and oriented in the same way.

The curved cell may be single curved or alternatively double curved.

In the cell arrangement when placed under the cover of a seat a surface normal of the convex surface should be arranged to point towards the cover.

When placed underneath the cover there is less seat show through with a curved cell than with planar fluid cells, as the edges of the cell are arranged inwards pointing away from the trim. Hence, there is also less wear on the seat cover from edges of the cells compared to with planar cells.

The fluid cells in deflated condition may be substantially cup-shaped or trough-shaped.

The fluid cells may be connected to a support structure having a first major surface and a second major surface, wherein the first major surface and the second major surface may be arranged on substantially opposite sides of the support structure, and wherein all fluid cells may be connected to the same major surface of the support structure.

The support structure may preferably be a sheet or two superimposed connected sheets.

The support structure may be a flexible sheet material such that inflation of cells is not obstructed by the support structure and such that the support structure conforms to a change of shape of the cells during inflation/deflation thereof.

The support structure may substantially be made of plastics.

The cells may be directly connected to the support structure by means of welding (if the support structure and the cell comprise plastics), gluing etc.

The plastic material may be a plastic film, foil or sheet. The plastic material could e.g. be polyethylene, polypropylene, polyester, polyvinyl chloride or polyurethane. In one example the plastic material is thermoplastic polyurethane (TPU) foil. The support structure may be made of different materials and of different plastics. For example could a first major surface of the support structure be of a first material and the second major surface be of a second material.

The fluid cells may be connected to the support structure in the series of successive fluid cells such that they are held at a predetermined distance overlapping one another. The fluid cells may be symmetrically connected to the support structure. The fluid cells may be oriented on the support structure in the same way.

The fluid cells may be connected to the support structure with a peripheral edge thereof or a peripheral projection thereof, and wherein all cells substantially may have the same orientation on the support structure.

At least a portion of the fluid cells and the support structure may be made of weldable material and the fluid cells may be welded to the support structure.

The welding method used may be electric welding.

Alternatively, the support structure is made of another material such as fabric, cardboard etc., and the cells connected thereto by means of e.g. gluing.

The support structure with fluid cells may be arranged directly underneath the seat cover of a seat. It could e.g. be arranged in the back of the seat or in the seat cushion.

Curved fluid cells/fluid cells may be connected to the support structure in such a way that a surface normal of the generally convex first major surface of a curved deflated fluid cell substantially is pointing in a direction which is orthogonal to the main direction of extension of the series of successive fluid cells and substantially pointing away from the major surface of the support structure to which the cell is connected.

Hence, edges of the fluid cells are not pointing towards the trim of the seat when the support structure with fluid cells is arranged in the seat with the fluid cells arranged closer to the seat cover than the support structure itself.

According to a second aspect there is provided a massage cell system comprising the massage cell arrangement discussed above and further comprises a fluid system for sequential inflation/deflation of the cells of the massage cell arrangement.

According to a third aspect there is provided massage cell system comprising two of the massage cell arrangements discussed above arranged such that their main directions of extension are substantially parallel and such that first massage cells of the two massage cell arrangements form a first pair of massage cells, and further comprising a fluid system for sequential inflation/deflation of the cells of the massage cell arrangement and for substantially simultaneous inflation/deflation of a pair of cells formed by the two massage cell arrangements.

The first fluid cells of the two series of fluid cells form a first pair of fluid cells, the second fluid cells of the two series of fluid cells form a second pair of fluid cells, etc.

All fluid cells of the two series of fluid cells may be connected to the same major surface of the support structure.

Alternatively, the two series of cells may be connected to separate support structures which may be connectable.

When the fluid cells are multi-cells, base cells of a pair of fluid cells are inflated at the same time and top cells at the same time. The base cells may be directly connected to the fluid system through a fluid connection. The top-cells are indirectly connected to the fluid system through their fluid connection with the base cell.

The fluid system may comprise a first fluid connection which is in direct fluid connection with each of the cells of a first pair of fluid cells and in indirect fluid connection with the cells of a second successive pair of fluid cells, wherein second fluid connections are arranged between the first and second cell of successive cells of the first and second series of successive cells, respectively.

Hence, each first fluid connection of the fluid system may supply fluid (directly and indirectly) to at least four fluid cells, i.e. eight fluid cells in a pair of two double cells.

In the case of multi-cells, the first fluid connection is in direct fluid contact with the respective base fluid cells of the first pair of fluid multi-cells. Fluid from the base fluid cell is flowing to the top fluid cell through any intermediate fluid cell. Hence, there is a delay in the inflation of the top fluid cells as compared to the base fluid cells in the first pair of fluid cells. The second connection is arranged between the base fluid cells of two successive multi-cells in a series of cells. Hence, fluid flows from the first base fluid cell through the second connection to the base fluid cell of the successive fluid cell and further to the top fluid cell and any intermediate fluid cell. Hence, there is a delay in the inflation of the second multi-cell as compared to the first multi-cell in the series of successive cells.

There is, hence, a slimmed fluid system as compared to if single fluid cells are used instead of multi-cells and compared to if each series of fluid cells had its own fluid system and to if each cell had its own first fluid connection. With the present fluid system comprising first and second fluid connections sequential inflation/deflation is possible.

When the massage cell arrangement comprises more than four pairs of fluid cells, further first fluid connections and second fluid connections may be added to control the inflation/deflation of further pairs of fluid cells.

The fluid connections may comprise restrictors or valves arranged for controlling fluid flow to and from the fluid cells to provide the sequential inflation/deflation along the series of successive fluid cells.

The restrictors may be arranged as areas of reduced flow cross-section in the fluid connections of the fluid system.

At least a portion of the fluid system may be connected to the support structure.

Alternatively or additionally, at least a portion of the fluid system may be incorporated in the support structure.

Fluid connections may be arranged in the support structure. Fluid connections may be arranged in the support structure through welding of the support structure material if the support structure material is of a weldable material.

At least a portion of the fluid system may be connected to or integrated in the support structure to which the first and second series of fluid cells may be connected.

### BRIEF DESCRIPTION OF THE DRAWINGS

FIG. 1 schematically shows a massage cell.

FIG. 2 shows fluid double cells.

FIG. 3 shows how fluid cells are in fluid connection with a fluid system.

FIG. 4 shows a curved fluid cell.

FIG. 5 shows a series of curved overlapping fluid cells.

FIG. 6 shows a cross-section of a curved fluid cell.

FIG. 7 shows a cross-section of another curved fluid cell.

### DETAILED DESCRIPTION

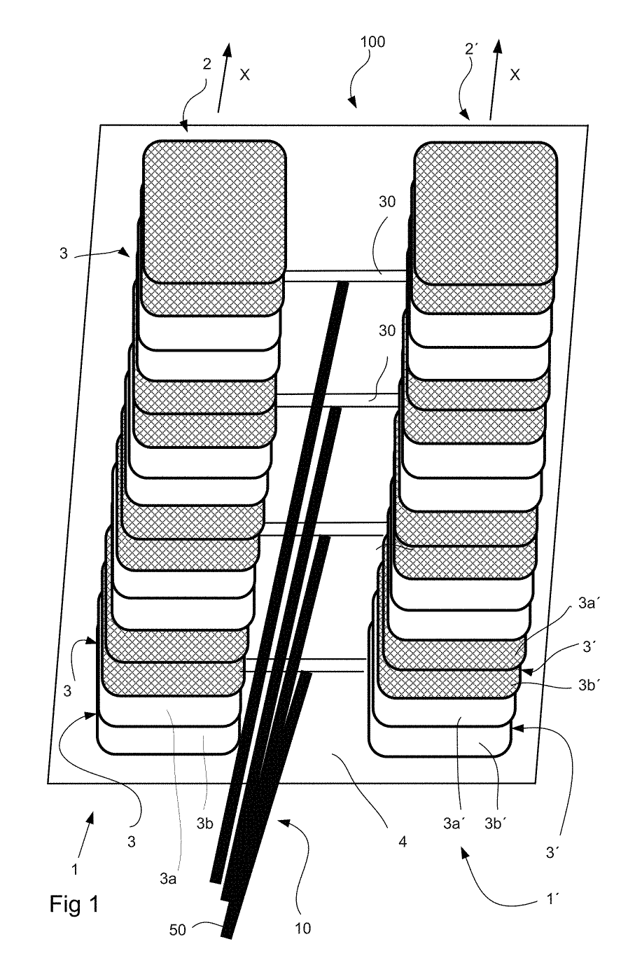

FIG. 1 shows a massage cell arrangement 1 for a massage system 100. The massage system could be arranged directly underneath the seat cover of a seat e.g. in the back, seat cushion or arm rest.

The massage system 1 of FIG. 1 comprises two parallel massage cell arrangements 1, 1′. Each massage cell arrangement comprises a series of successive inflatable/deflatable fluid cells 3, 3′. The cells of each series of cells 2, 2′ are substantially linearly arranged along a main direction of extension X of the series of cells. In a non-illustrated embodiment the massage system comprises only one series of successive fluid cells 2, 2′.

First fluid cells 3, 3′ of the two series of fluid cells 2, 2′ form a pair of fluid cells. Second fluid cells form a second pair etc.

In each series of fluid cells 2, 2′ the fluid cells may be oriented in substantially the same direction and overlap one another in a main direction of extension X of the series of fluid cells. The overlap of adjacent massage cells should be such that a first fluid cell covers 10-90% of a surface area of a major surface of the second fluid cell. In FIG. 1 there is an overlap of approximately 75%.

The fluid cells 3, 3′ of the two series of successive fluid cells 2, 2′ may be connected to the same major surface of a support structure 4 in such a way that they are held at a predetermined distance overlapping one another. Alternatively, the two series of cells 2, 2′ may be connected to separate support structures 4, which separate support structures may be connectable.

The support structure 4 may be a sheet or two superimposed connected sheets.

The fluid cells in FIG. 1 are shown as having substantially the same shape and dimensions. However, overlapping successive fluid cells 2, 2′ of different shape and dimensions are also possible.

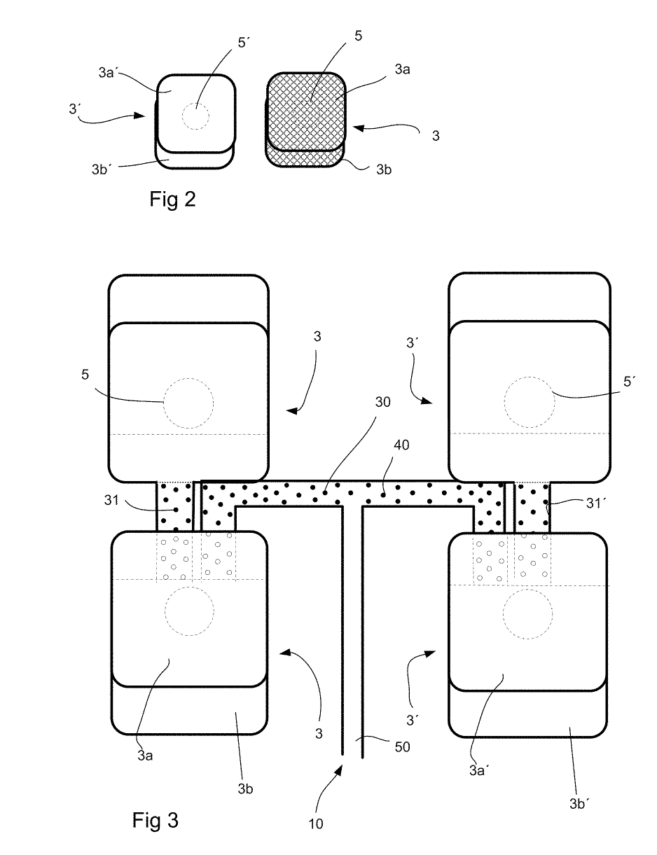

All fluid cells 3, 3′ are here multi-cells, double cells, see FIG. 2, consisting of a base fluid cell 3b, 3b′ connected to a top fluid cell 3a, 3a′ and arranged on top of each other. Multi-cells 3, 3′ comprising up to five fluid cells are possible (not shown) and consist of a base fluid cell 3b, 3b′ and a top fluid cell 3a, 3a′ with up to three intermediate fluid cells arranged in between. The top fluid cell 3a, 3a′ and the base fluid cell 3b, 3b′ are arranged offset in relation to each other such that 10-99% of the base fluid cell 3b, 3b′ is covered by the top fluid cell 3a, 3a′. In the figures, the overlap is approximately 75%.

If there are more than two fluid sub-cells in the fluid cell 3, 3′, any intermediate fluid cell may be offset in relation to the top fluid cell and/or the base fluid cell. In one embodiment, all fluid cells, i.e. top fluid cell, base fluid cell and any intermediate fluid cell, of a multi-cell are essentially the same kind of cells with regard to material, shape, size etc.

An opening 5, 5′ for fluid communication between adjacent fluid cells 3a, 3a′; 3b, 3b′ in a multi-cell may be provided in an area of connection between two adjacent fluid sub cells 3a, 3a′; 3b, 3b′. Fluid cells may for example be connected at a hinge region (not shown). Fluid cells 3a, 3a′; 3b, 3b′ may be connected at an area of overlap of the major surfaces of the fluid cells (FIG. 2).

For sequential inflation/deflation of the series of fluid cells 2, 2′ along the direction of extension X of the series of fluid cells 2, 2′ a fluid system 10 is arranged, to which the fluid cells 3, 3′, 3″ are connected through fluid connections 30, 31, 31′, see FIGS. 1 and 3.

At least a portion of the fluid system 10 may be connected to a support structure 4. Alternatively or additionally, at least a portion of the fluid system 10 may be incorporated in the support structure 4. Fluid connections 30, 31, 31′ may be arranged in the support structure 4. Fluid connections 30, 31, 31′ may be arranged in the support structure 4 through welding of the support structure 4 material if the support structure material is of a weldable material, such as plastics, e.g. polyurethane.

The fluid cells 3, 3′, 3″ may be connected to the support structure 4 with a peripheral edge thereof or a peripheral projection thereof, and such that all cells substantially have the same orientation on the support structure 4.

The fluid cells 3, 3′, 3 and the support structure 4 may be made of weldable material and the fluid cells 3, 3′, 3″ may be welded to the support structure 4, through for example electric welding.

Alternatively, the support structure is made of another material such as fabric, cardboard etc., and the cells connected thereto by means of e.g. gluing.

The two series of fluid cells 2, 2′ may be connected to the same fluid system 10 and each pair of fluid cells 3, 3′ of the two series of fluid cells 2, 2′ may be connected to the fluid system 10 through the same first fluid connection 30 in such a way that a pair of fluid cells is inflated/deflated approximately simultaneously.

Inflation of the fluid cells 3, 3′ in a series of fluid cells 2, 2′ takes place along the series of fluid cells in a wave-like manner and results in a movement along the extension X of the series of fluid cells.

The fluid system 10 may comprise a plurality of first and second fluid connections 30; 31, 31′, each first fluid connection 30 being in direct fluid connection with each of the cells in a first pair of fluid cells, as shown in FIG. 3. A pump (not shown) supplies fluid under pressure via a fluid channel 50 to the first fluid connection 30. If double-cells, the first fluid connection 30 is directly connected to the base fluid cells 3b, 3b′ of respective first fluid cells 3, 3′of a first pair of fluid cells of the two series of fluid cells 2, 2′. The top fluid cells 3a, 3a′ of the fluid cells of the first pair of fluid cells are supplied with fluid from the base fluid cells 3b, 3b′ via the opening 5, 5′ arranged between adjacent fluid cells 3a, 3a′; 3b, 3b′ in the two series of successive cells. Fluid from the respective base fluid cells 3b, 3b′ of the first pair of fluid cells is also supplied via second fluid connections 31, 31′ to respective base fluid cells 3b, 3b′ of fluid cells of the successive second pair of fluid double-cells 3, 3′. The top fluid cells 3a, 3a′ of the fluid cells of the second pair of fluid cells are supplied with fluid from the base fluid cells via the opening 5, 5′ for fluid communication between adjacent fluid cells 3a, 3a′; 3b, 3b′ in a multi-cell. Hence, the base fluid cell 3b, 3b′ of a multi-cell 3, 3′ is fully inflated slightly before the top fluid cell 3a, 3a′ and any intermediate fluid cell of a multi-cell, as fluid from the fluid system 10 first enters the base fluid cell 3b, 3b′ and thereafter flows to any intermediate fluid cell and to the top fluid cell 3a, 3a′.

In FIG. 3 the second pair of fluid double cells have been folded such that to show the first and second fluid connections 30, 31, 31′ more clearly.

Hence, via each first fluid connection 30 of the fluid system 10 fluid may be supplied (directly and indirectly) to at least four fluid cells 3, 3′, i.e. eight fluid cells in a pair of two double cells. Via similar connection arrangements, the next two pairs of fluid cells in the series of successive fluid cells 2, 2′ are also supplied with fluid from the pump via a fluid channel 50 and a first and second fluid connector 30, 30′, 31, 31′.

In an alternative embodiment it is, however, possible that the massage cell arrangement comprises only one series of fluid cells and hence the fluid system only supplies fluid to one series of fluid cells.

In one embodiment e.g. twelve or sixteen fluid cells may be in fluid connection through the same first fluid connection.

The fluid connections 30, 31, 31′ may comprise restrictors (shown as dots 40 FIG. 3) in the fluid connections 30, 31, 31′ arranged for controlling fluid flow to and from the fluid cells 3, 3′ to provide the sequential inflation/deflation along the series of successive fluid cells 2, 2′. The restrictors are here arranged as areas of reduced flow cross-section in the fluid connections of the fluid system. In the case the fluid system or a portion of the fluid system is integrated in the support structure, the fluid connections and the restrictors therein may be arranged through a welding process of the supporting structure. With this massage cell arrangement there is inflation in one direction along the extension X of the fluid cells, i.e. there is no inflation in the opposite direction.

In an alternative embodiment restrictors are not used but a plurality of controllable valves as shown in U.S. Pat. No. 5,153,282.

The massage system may further comprise venting means for venting the fluid system (not shown). The massage system may further comprise a control unit or switch for controlling the operation of the pump (not shown).

The series of fluid cells 3, 3′ shown in FIG. 1 each comprises eight “offset” double cells 3, 3′. Series of cells comprising up to 50 multi-cells or more are, however, possible. It also possible that not all fluid cells 3, 3′ of a series of fluid cells are multi-cells. For example, the first and last fluid cells of a series of fluid cells could be so called “single” fluid cells. However, to reach the desired effect of a more even inflation/deflation of the sequence of overlapping successive fluid cells 2, 2′ and an increased wave-like and smooth massage feeling, at least 50% of the fluid cells in a series of fluid cells should be multi-cells and preferably “offset” multi-cells.

The major surfaces of a fluid cell (3, 3′) in deflated condition may have any shape and is in FIGS. 1-3 shown as being substantially quadratic with round corners.

In one non-limiting example a double cell comprises two fluid cells 3a, 3a′; 3b, 3b′ with quadratic major surfaces having a side length of 65 mm. The offset of the top fluid cell 3a, 3a′ in relation to the base fluid cell 3b, 3b′ is such that the top fluid cell covers 85% of the base fluid cell.

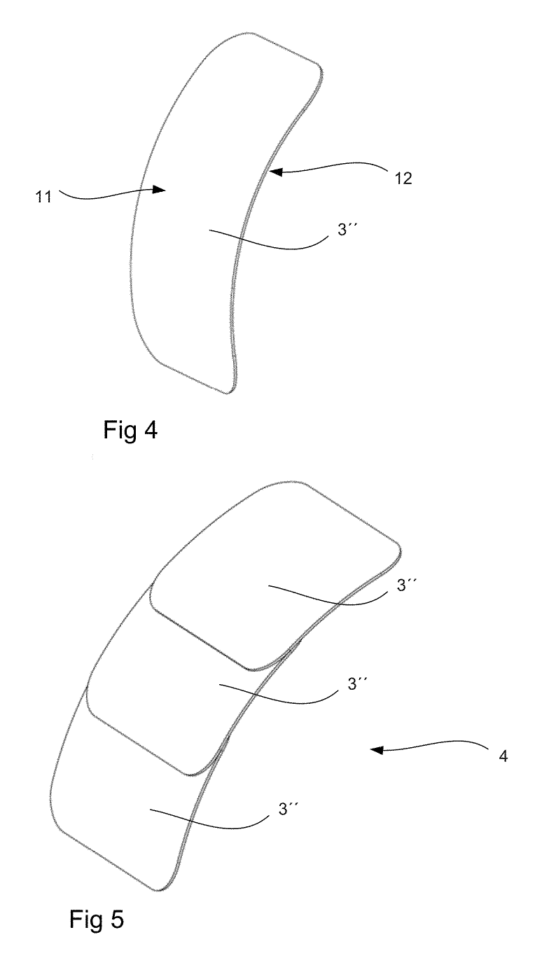

The fluid cells 3, 3′ in deflated condition as seen in FIGS. 1-3 may be substantially planar. Alternatively, the fluid cells 3″ in deflated condition may be curved, FIGS. 4-7, such that the cells 3″ present a generally convex first major surface 11. In a preferred embodiment the fluid cell 3″ also presents a generally concave second major surface 12, the first and second major surface being substantially complementary surfaces being are arranged on substantially opposite sides of the fluid cell 3″. Also multi-cells may consist of curved fluid cells (not shown).

That the fluid 3″ is curved in the deflated condition means that also after a plurality of inflations/deflations the cell may remain curved in its deflated condition.

Depending on the degree of inflation, the fluid cell may or may not exhibit any curvature in the inflated condition.

As seen in FIG. 4 or 5, the first major surface 11 of a fluid cell 3 may be single curved.

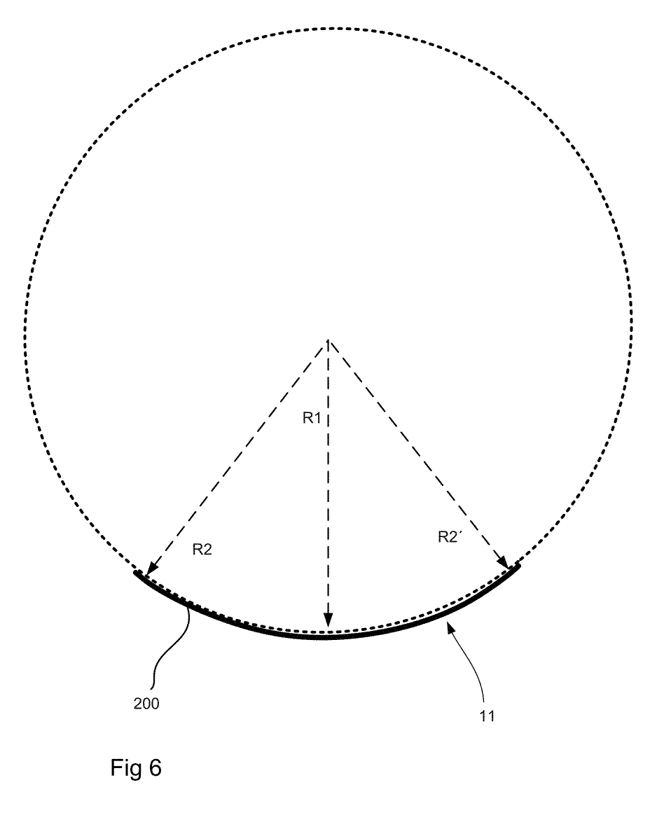

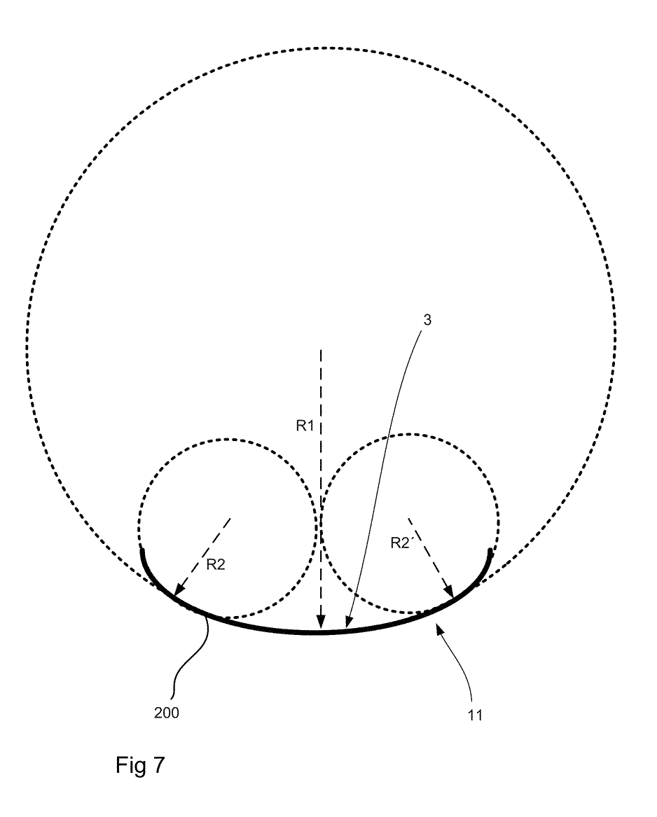

A concavity of a cross sectional curve 200 (see FIG. 6 or 7), which is obtained from a cross section taken through the convex first major surface 11 of a fluid cell 3″ such that the cross section comprises the largest convexity of the first major surface 11 and a surface normal to the convex first major surface, may have substantially the same radius of curvature R1, R2, R2′ along the cross sectional curve as shown in FIG. 6.

The radius of curvature R1, R2, R2′ may be 30-300%, 50-250%, 75-200% or 100-150% of a length of the cross sectional curve 200.

In one non-limiting example the first major surface 11 of the massage cell 3″ is of substantially rectangular shape in the deflated condition, the rectangle having a first side of about 65 mm and a second side of about 60 mm. The largest convexity of the first major surface 11 is arranged as shown in FIG. 4 and the radius of curvature of the cross sectional curve is about 80 mm along the cross sectional curve.

Alternatively, as shown in FIG. 7, the concavity may comprise a largest radius of curvature R1 and a smallest radius of curvature R2, R2′.

The largest radius of curvature may be 30-300%, 50-250%, 75-200% or 100-150% of a length of the cross sectional curve and the smallest radius of curvature may be 20-99% of the largest radius of curvature.

In FIG. 7 the second smallest radius of curvature R2, R2′ of the cross sectional curve is about 30% of the first largest radius of curvature R1.

As in FIG. 7, the largest radius of curvature R1 may be located at a centre portion of the cross sectional curve 200 and the smallest radius of curvature R2, R2′ at a peripheral portion of the cross sectional curve 200.

In FIG. 7, there are two substantially opposite peripheral second smallest radius of curvature R2, R2′ which are of approximately the same size.

Alternatively, the smallest radius of curvature may be located at a centre portion of the cross sectional curve 200 and the largest radius of curvature at a peripheral portion of the cross sectional curve.

Alternatively, the major surface may be double curved (not shown).

In such case, the generally convex first major surface may be double curved such that two mutually orthogonal cross sections, a first and second cross section, of the convex first major surface comprises a respective surface normal to the convex first major surface and a respective convexity. A largest radius of curvature of a first cross sectional curve obtained from the first cross section may be 30-300%, 50-250%, 75-200% or 100-150% of a length of the first cross sectional curve.

A discussed above, the major surfaces 11, 12 of the massage cell 3″ in deflated condition may be rectangular. Other substantially polygonal or semi-polygonal shapes are also possible as well as round or oval shapes.

The curved fluid cells 3″ in deflated condition may be substantially cup-shaped or trough-shaped.

Curved fluid cells 3″ may be connected to the support structure 4 in such a way that a surface normal of the generally convex first major surface 12 of the curved fluid cell 3″ is substantially orthogonal to the main direction of extension of the series of successive cells and pointing away from the major surface of the support structure 4 to which the cell is connected.

Hence, edges of the fluid cells are not pointing towards the trim of the seat when the massage cell system 1 is arranged in the seat with the fluid cells arranged closer to the seat cover than the support structure 4.

1. A massage cell arrangement (1, 1′) for a vehicle seat comprising:
a plurality of inflatable/deflatable fluid cells (3, 3′, 3″) arranged in a series of successive fluid cells (2, 2′), each fluid cell (3, 3′, 3″) having a first and second major surface arranged on substantially opposite sides of the cell, the cell being configured for fluid connection with a fluid system (10) for inflation/deflation of the fluid cell (3, 3′, 3″),
the fluid cells (3, 3′, 3″) of a series of successive fluid cells (2, 2′) being substantially aligned along the main direction of extension (X) of the series of successive fluid cells (2, 2′), a surface normal of a major surface of a deflated cell (3, 3′, 3″) being substantially orthogonal to the main direction of extension (X) of the series of successive fluid cells (2, 2′); and
wherein the fluid cells (3, 3′, 3″) are arranged to overlap with one another such that in each pair of successive cells, a first cell and a second cell are partially covering each other, and a portion of the fluid cells (3, 3′, 3″) in the series of successive fluid cells (2, 2′) are multi-cells comprising at least two connected fluid cells (3a, 3b; 3a′, 3b′), each multi-cell comprising at least a base fluid cell (3b, 3b′) and a top fluid cell (3a, 3a′), wherein internal spaces of the fluid cells of the multi-cell are in fluid communication with each other, and wherein the top fluid cell (3a, 3a′) and the base fluid cell (3b, 3b′) are arranged in such a way that the top fluid cell (3a, 3a′) partially covers a major surface of the base fluid cell (3b, 3b′).

2. The massage cell arrangement (1, 1′) of claim 1, wherein a number of fluid cells (3a, 3a′, 3b, 3b′) in a multi-cell (3, 3′) is 2 to 3.

3. The massage cell arrangement (1, 1′) of claim 1, wherein the top fluid cell (3a, 3a′) covers 10-99% of a major surface of the base fluid cell (3b, 3b′) in a multi-cell.

4. The massage cell arrangement (1, 1′) of claim 1, wherein a number of multi-cells (3, 3′) in relation to a total number of fluid cells (3, 3′) in the series of successive fluid cells (2, 2′) is at least 30%.

5. The massage cell arrangement (1, 1′) of claim 1, wherein the adjacent fluid cells (3, 3′, 3″) overlap such that a first fluid cell covers 10-99% of a major surface of a second fluid cell.

6. The massage cell arrangement (1, 1′) of claim 1, wherein fluid cells (3, 3′, 3″) substantially are made of plastics.

7. The massage cell arrangement (1, 1′) of claim 1, wherein the major surfaces of the fluid cells (3, 3′, 3″) in deflated condition are substantially polygonal, semi-polygonal, round or oval.

8. The massage cell arrangement (1, 1′) of claim 1, wherein the fluid cells (3, 3′, 3″) in deflated condition are substantially planar.

9. The massage cell arrangement (1, 1′) of claim 1, wherein the fluid cells (3″) in a deflated condition are curved such that the fluid cell presents a generally convex first major surface (11).

10. The massage cell arrangement (1, 1′) of claim 9, wherein the fluid cells (3″) in a deflated condition are substantially cup-shaped or trough-shaped.

11. The massage cell arrangement (1, 1′) of claim 1, wherein the fluid cells (3, 3′, 3″) are connected to a support structure (4) having a first major surface and a second major surface, wherein the first major surface and the second major surface are arranged on substantially opposite sides of the support structure, and wherein all fluid cells (3, 3′, 3″) are connected to the same major surface of the support structure (4).

12. The massage cell arrangement (1, 1′) of claim 11, wherein a fluid cell (3, 3′, 3″) is connected to the support structure (4) with a peripheral edge thereof or a peripheral projection thereof, and wherein all cells substantially have the same orientation on the support structure.

13. The massage cell arrangement (1, 1′) of claim 11, wherein at least a portion of the fluid cells (3, 3′, 3″) and the support structure (4) are made of weldable material and the fluid cells are welded to the support structure.

14. The massage cell arrangement (1, 1′) of claim 11, wherein the fluid cells (3″) are connected to the support structure (4) in such a way that a surface normal of the generally convex first major surface (11) of a curved deflated fluid cell (3″) substantially is pointing in a direction which is orthogonal to the main direction of extension (X) of the series of successive fluid cells and substantially pointing away from the major surface of the support structure (4) to which the cell is connected.

15. A massage cell system (100), comprising:
a massage cell arrangement (1, 1′), comprising:
a plurality of inflatable/deflatable fluid cells (3, 3′, 3″) arranged in a series of successive fluid cells (2, 2′), each fluid cell (3, 3′, 3″) having a first and second major surface arranged on substantially opposite sides of the cell, the cell being configured for fluid connection with a fluid system (10) for inflation/deflation of the fluid cell (3, 3′, 3″),
the fluid cells (3, 3′, 3″) of a series of successive fluid cells (2, 2′) being substantially aligned along the main direction of extension (X) of the series of successive fluid cells (2, 2′), a surface normal of a major surface of a deflated cell (3, 3′, 3″) being substantially orthogonal to the main direction of extension (X) of the series of successive fluid cells (2, 2′);
wherein the fluid cells (3, 3′, 3″) are arranged to overlap with one another such that in each pair of successive cells, a first cell and a second cell are partially covering each other, and a portion of the fluid cells (3, 3′, 3″) in the series of successive fluid cells (2, 2′) are multi-cells comprising at least two connected fluid cells (3a, 3b; 3a′, 3b′), each multi-cell comprising at least a base fluid cell (3b, 3b′) and a top fluid cell (3a, 3a′), wherein internal spaces of the fluid cells of the multi-cell are in fluid communication with each other, and wherein the top fluid cell (3a, 3a′) and the base fluid cell (3b, 3b′) are arranged in such a way that the top fluid cell (3a, 3a′) partially covers a major surface of the base fluid cell (3b, 3b′); and
a fluid system (10) for sequential inflation/deflation of the cells (3, 3′, 3″) of the massage cell arrangement.

16. The massage cell system (100) of claim 15, comprising two of the massage cell arrangements (1, 1′) arranged such that their main directions of extension (X) are substantially parallel and such that fluid cells (3, 3′, 3″) of the two massage cell arrangements (1, 1′) form a first pair of massage cells, and the fluid system (10) is arranged for substantially simultaneous inflation/deflation of a pair of cells formed by the two massage cell arrangements (1, 1′).

17. The massage cell system (100) of claim 16, wherein all fluid cells (3, 3′, 3″) of the successive fluid cells (2, 2′) are connected to the same major surface of a support structure (4).

18. The massage cell system (100) of claim 16, wherein the fluid system (10) comprises a first fluid connection (30) which is in direct fluid connection with each of the fluid cells (3, 3′, 3″) of a first pair of fluid cells and in indirect fluid connection with the cells of a second pair of fluid cells, wherein second fluid connections (31, 31′) are arranged between the first and second cell of successive cells of first and second series of successive cells, respectively.

19. The massage cell system (100) of claim 18, wherein the fluid connections (30, 31, 31′) comprises restrictors or valves arranged for controlling fluid flow to and from the fluid cells to provide the sequential inflation/deflation along the series of successive fluid cells (2, 2′).

20. The massage cell system (100) of claim 19, wherein the restrictors (40) are arranged as areas of reduced flow cross-section in the fluid connections (30, 31, 31′) of the fluid system (10).

21. The massage cell system (100) of claim 17, wherein at least a portion of the fluid system (10) is connected to the support structure (4).

22. The massage cell system (100) of claim 17, wherein at least a portion of the fluid system (10) is incorporated in the support structure (4).
